(19) United States
(12) Patent Application Publication
(10) Pub. No.: US 2016/0339898 A1
(43) Pub. Date: Nov. 24, 2016

(54) WORK VEHICLE

(71) Applicant: KOMATSU LTD., Tokyo (JP)

(72) Inventors: Mitsuhiko KAMADO, Hirakata-shi (JP); Kouichi MIYATAKE, Kawasaki-shi (JP); Junpei UEDA, Hirakata-shi (JP)

(21) Appl. No.: 14/437,054

(22) PCT Filed: Dec. 4, 2014
(86) PCT No.: PCT/JP2014/082117

§ 371 Date: Apr. 20, 2015

(51) Int. Cl. B60W 20/00; B60L 1/02; B60W 10/30; F01P 5/04; E02F 9/20; F01P 3/20; F01P 1/06; B60K 11/06; E02F 9/08

(52) U.S. Cl. CPC B60W 20/00; B60K 11/06; B60L 1/02; B60W 10/30; E02F 9/0866; E02F 9/2095; F01P 3/20; F01P 1/06; F01P 5/04; B60W 2510/0676; B60W 2510/087; B60W 2300/17; Y10S 903/904; E02F 3/32

(57) ABSTRACT

A work vehicle includes a plurality of hybrid instruments, a cooling medium circuit, a radiator, a fan, a variable mechanism, a plurality of sensors, and a fan control unit. The cooling medium circuit communicates with the plurality of hybrid instruments to cause a cooling medium for cooling the plurality of hybrid instruments to circulate through the hybrid instruments. The radiator is connected to the cooling medium circuit. The fan generates cooling wind for cooling the radiator. The variable mechanism is capable of changing the number of rotations of the fan. The plurality of sensors are provided in correspondence with the plurality of hybrid instruments, respectively, each detecting the temperature of a corresponding one of the hybrid instruments. The fan control unit controls the variable mechanism based on the temperatures detected by the plurality of sensors, to control the number of rotations of the fan.

### TECHNICAL FIELD

The present invention relates to a work vehicle.

### BACKGROUND ART

Generally, a cooling fan is coupled to an engine of a work vehicle. For example, PTD 1 discloses a fan coupled to an output shaft of an engine via a clutch (fan clutch). The fan clutch can adjust the number of rotations of the fan.

PTD 1 discloses a scheme for controlling connection/disconnection of the fan clutch by setting a threshold value for determining whether or not, for example, an engine coolant or the like is within a predetermined temperature range, and performing control based on whether or not the threshold value is exceeded, for the control of the number of rotations of the fan.

PTD 2 discloses a scheme for controlling a fan clutch by estimating an operation state of a vehicle and using a control map for adjusting the number of rotations of a fan corresponding to the estimated operation state, for the control of the fan clutch.

### CITATION LIST

### Patent Document

PTD 1: Japanese Patent Laying-Open No. 2005-3131

PTD 2: Japanese Patent Laying-Open No. 2013-47470

### SUMMARY OF INVENTION

### Technical Problem

On the other hand, recently, a hydraulic excavator is being hybridized using both an engine and an electric motor as power sources. In this hybrid hydraulic excavator, an electric motor system having an electric instrument (also referred to as a hybrid instrument) such as an inverter needs to be cooled in addition to a conventional cooling object. However, PTD 1 and PTD 2 described above do not disclose efficiently adjusting the number of rotations of the fan to cool the hybrid instrument.

The present invention was made to solve the aforementioned problem, and an object of the present invention is to provide a work vehicle capable of efficiently controlling the number of rotations of a fan based on a state of a hybrid instrument.

Other tasks and novel features will become apparent from the description herein and the attached drawings.

### Solution To Problem

A work vehicle according to an aspect of the present invention includes a plurality of hybrid instruments, a cooling medium circuit, a radiator, a fan, a variable mechanism, a plurality of sensors, and a fan control unit. The cooling medium circuit communicates with the plurality of hybrid instruments to cause a cooling medium for cooling the plurality of hybrid instruments to circulate through the hybrid instruments. The radiator is connected to the cooling medium circuit. The fan generates cooling wind for cooling the radiator. The variable mechanism is capable of changing a number of rotations of the fan. The plurality of sensors are provided in correspondence with the plurality of hybrid instruments, respectively, each detecting a temperature of a corresponding one of the hybrid instruments. The fan control unit controls the variable mechanism based on the temperatures of the hybrid instruments detected by the plurality of sensors to control the number of rotations of the fan.

According to the work vehicle in the present invention, since the fan control unit controls the variable mechanism based on the temperatures detected by the plurality of sensors to control the number of rotations of the fan, the number of rotations of the fan can be efficiently controlled based on the state of each hybrid instrument.

Preferably, the work vehicle further includes a storage unit. The storage unit stores a plurality of pieces of relationship data defining relationship between the temperatures of the hybrid instruments and the number of rotations of the fan in accordance with the plurality of hybrid instruments. The fan control unit controls the number of rotations of the fan to be the highest number of rotations among numbers of rotations of the fan set in accordance with the plurality of pieces of relationship data stored in the storage unit based on the temperatures detected by the plurality of sensors, respectively.

According to the above, since the fan control unit controls the number of rotations of the fan such that the number of rotations of the fan set in accordance with the plurality of pieces of relationship data stored in the storage unit based on the temperatures detected by the plurality of sensors becomes the highest number of rotations, the number of rotations of the fan can be efficiently controlled.

Preferably, the fan control unit controls the variable mechanism based on a temperature of a hydraulic oil used in the work vehicle and the temperatures detected by the plurality of sensors to control the number of rotations of the fan. The storage unit further stores hydraulic oil relationship data for setting the number of rotations of the fan at a different number of rotations of the fan in accordance with the temperature of the hydraulic oil for cooling the hydraulic oil. A change rate of the number of rotations of the fan from the minimum number of rotations to the maximum number of rotations with respect to a temperature change of each of the hybrid instruments is higher than a change rate of the number of rotations of the fan from the minimum number of rotations to the maximum number of rotations with respect to a temperature change of the hydraulic oil in the hydraulic oil relationship data.

According to the above, the change rate of the number of rotations of the fan from the minimum number of rotations to the maximum number of rotations with respect to the temperature change of each of the hybrid instruments is higher than the change rate of the number of rotations of the fan from the minimum number of rotations to the maximum number of rotations with respect to the temperature change of the hydraulic oil in the hydraulic oil relationship data. Therefore, a suitable number of rotations of the fan can be set for rapidly-changing temperatures of electronic components.

Preferably, the plurality of pieces of relationship data each include a first region in which a change rate of the number of rotations of the fan with respect to a temperature change of a corresponding one of the hybrid instruments is low, and a second region after the first region in which the change rate is higher than in the first region.

According to the above, since the number of rotations of the fan is set in the order of the region in which the change rate of the number of rotations of the fan is low and the region in which the change rate is high, the number of rotations of the fan can be efficiently controlled without unnecessarily increasing the number of rotations.

Preferably, the work vehicle further includes an engine. The engine supplies a drive force for rotation to the fan. The variable mechanism is provided between the engine and the fan.

According to the above, since the number of rotations of the fan can be changed with respect to the number of rotations of the engine, fuel efficiency of the engine can be improved by appropriately adjusting the number of rotations of the fan.

### Advantageous Effects Of Invention

The number of rotations of a fan can be efficiently controlled based on a state of a hybrid instrument.

### BRIEF DESCRIPTION OF DRAWINGS

FIG. 1 is a diagram illustrating an appearance of a work vehicle 101 based on an embodiment.

FIG. 2 is a perspective view showing a configuration of a cooling unit based on the embodiment.

FIG. 3 is a perspective view showing a configuration of the back side of the cooling unit based on the embodiment.

FIG. 4 is a diagram of an appearance of a fan 200 based on the present embodiment.

FIG. 5 is a diagram illustrating a construction of a fan drive portion 210 based on the present embodiment.

FIG. 6 is a diagram illustrating a cooling system 300 based on the embodiment.

FIG. 7 is a diagram illustrating a circulation path L of cooling system 300 based on the embodiment.

FIG. 8 a functional block diagram for controlling fan 200 based on the embodiment.

FIG. 9 is a diagram illustrating a structure of a plurality of control maps based on the embodiment.

FIG. 10 is a conceptual diagram for controlling fan 200 using the plurality of control maps.

### DESCRIPTION OF EMBODIMENTS

An embodiment of the present invention will be described hereinafter with reference to the drawings.

<Overall Configuration>

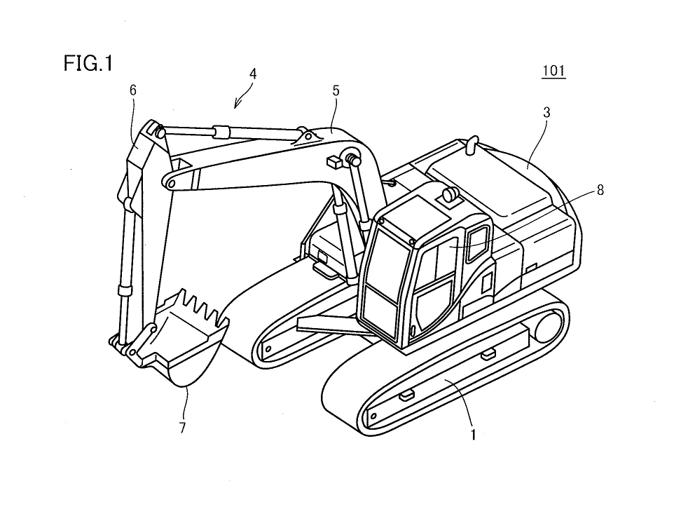

FIG. 1 is a diagram illustrating an appearance of a work vehicle 101 based on an embodiment.

As shown in FIG. 1, in the present example, a hybrid-type hydraulic excavator will mainly be described by way of example as work vehicle 101 based on the embodiment.

The hybrid-type hydraulic excavator includes a swing electric motor, a generator motor, an inverter as a converter, a capacitor as a condenser, an engine, and the like. In the hybrid-type hydraulic excavator, the capacitor stores electric energy generated by the swing electric motor during deceleration of body revolution and electric energy generated by the generator motor directly coupled to the engine. The electric energy stored in the capacitor is utilized as auxiliary energy when accelerating the engine through the generator motor. It is noted that “forward”, “rearward”, “left”, and “right” in the following description refer to the directions determined with respect to an operator seated on an operator's seat.

Work vehicle 101 mainly includes a carrier 1, a revolving unit 3, and a work implement 4. A work vehicle main body is constituted of carrier 1 and revolving unit 3. Carrier 1 has a pair of left and right crawler belts. Revolving unit 3 is attached revolvably, with a revolving mechanism (swing electric motor) in an upper portion of carrier 1 being interposed.

Work implement 4 is pivotably supported by revolving unit 3 in a manner operable in a vertical direction, and performs such working as excavation of soil. Work implement 4 includes a boom 5, an arm 6, and a bucket 7. Boom 5 is movably coupled to revolving unit 3 at a root portion. Arm 6 is movably coupled to a tip end of boom 5. Bucket 7 is movably coupled to a tip end of arm 6. In addition, revolving unit 3 includes an operator's cab 8 and the like. In the rear portion of revolving unit 3, the engine is arranged, as well as a cooling unit which will be described later.

<Configuration of Cooling Unit>

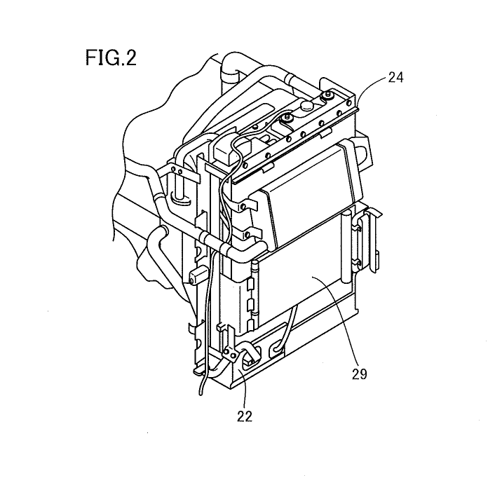

FIG. 2 is a perspective view showing a configuration of a cooling unit based on the embodiment.

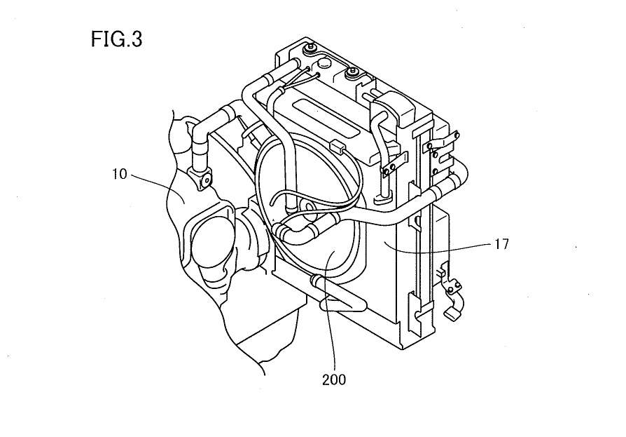

FIG. 3 is a perspective view showing a configuration of the back side of the cooling unit based on the embodiment.

As shown in FIG. 2, the cooling unit includes, as cooling objects, an oil cooler 22 for cooling a hydraulic oil used to drive work implement 4, an engine radiator 24 for cooling an engine coolant which cools an engine, and a radiator (also referred to as a hybrid radiator) 29 for cooling a coolant (also referred to as a hybrid coolant) for cooling an electric motor system. It is noted that although the present example illustrates the configuration where water is used as a cooling medium, water is not a particular limitation, but another cooling medium having high cooling efficiency can also be used.

Oil cooler 22 receives supply of the hydraulic oil from an oil cooler inlet not shown, and the cooled hydraulic oil is discharged from an oil cooler outlet.

Engine radiator 24 receives supply of the engine coolant from a radiator inlet hose not shown, and the cooled engine coolant is discharged from a radiator outlet hose.

Hybrid radiator 29 receives supply of the hybrid coolant from a radiator inlet hose not shown to discharge the cooled hybrid coolant from a radiator outlet hose.

As shown in FIG. 3, a fan 200 is provided on the back side of the cooling unit to cool the cooling unit with cooling wind from the fan. Further, fan 200 is coupled to an output shaft of engine 10 and rotated. In addition, a fan cover 17 is provided to cover fan 200.

<Configuration of Fan>

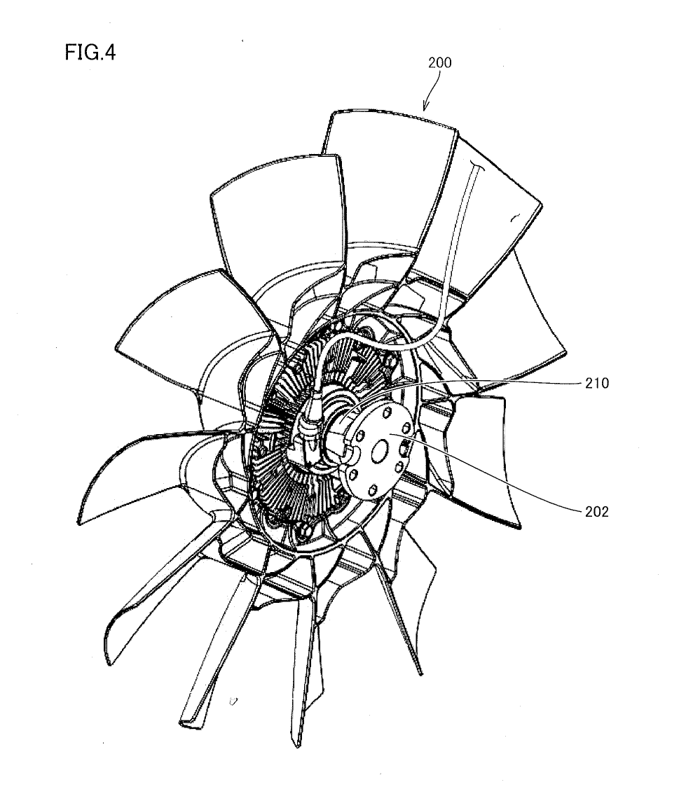

FIG. 4 is an appearance diagram of fan 200 based on the present embodiment.

Referring to FIG. 4, fan 200 is constituted of 11 blades. A fan drive portion 210 is coupled to an output shaft 202 of engine 10, and controls rotation of fan 200 by means of a fluid clutch.

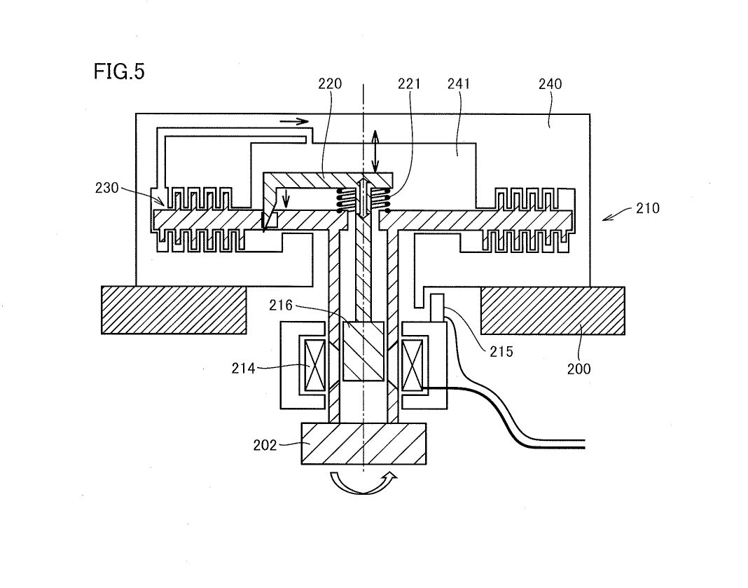

FIG. 5 is a diagram illustrating a configuration of fan drive portion 210 based on the present embodiment.

Referring to FIG. 5, fan drive portion 210 includes a case 240, a clutch portion 230, a spring 221, a solenoid movable element 216, a solenoid coil 214, an adjustment member 220, and a hall element 215.

An oil reservoir 241 within case 240 is filled with silicon oil, and rotation of fan 200 is controlled by adjusting the amount of silicon oil to clutch portion 230.

Solenoid movable element 216 is coupled to adjustment member 220. By increasing the amount of current supplied to solenoid coil 214, solenoid movable element 216 compresses spring 221 to push down adjustment member 220. On the other hand, by decreasing the amount of current supplied to solenoid coil 214, a force pushing down solenoid movable element 216 is weakened, and a repulsion force of spring 221 pushes up adjustment member 220.

In accordance with the position of adjustment member 220, the amount of silicon oil which flows from oil reservoir 241 to clutch portion 230 is adjusted. By pushing down adjustment member 220, the amount of silicon oil which flows into clutch portion 230 decreases. On the other hand, by pushing up adjustment member 220, the amount of silicon oil which flows into clutch portion 230 increases.

With a change in the amount of silicon oil, shear resistance changes and the number of rotations of fan 200 changes. With an increase in the amount of silicon oil which flows into clutch portion 230, shear resistance increases and the number of rotations of fan 200 increases. On the other hand, with a decrease in the amount of silicon oil which flows into clutch portion 230, shear resistance lowers and the number of rotations of fan 200 decreases.

Hall element 215 detects the number of rotations of fan 200 and outputs a detection result to a fan controller which will be described later. The fan controller controls the amount of current supplied to solenoid coil 214 such that the number of rotations of fan 200 detected by hall element 215 attains a desired number of rotations.

Although the case where fan drive portion 210 employs a scheme for adjusting the number of rotations of fan 200 by means of a fluid clutch using silicon oil has been described, the scheme employed by fan drive portion 210 is not particularly limited thereto, and fan drive portion 210 may employ such a scheme as an electromagnetic clutch to adjust the number of rotations of fan 200.

<Cooling Structure for Electric Motor System>

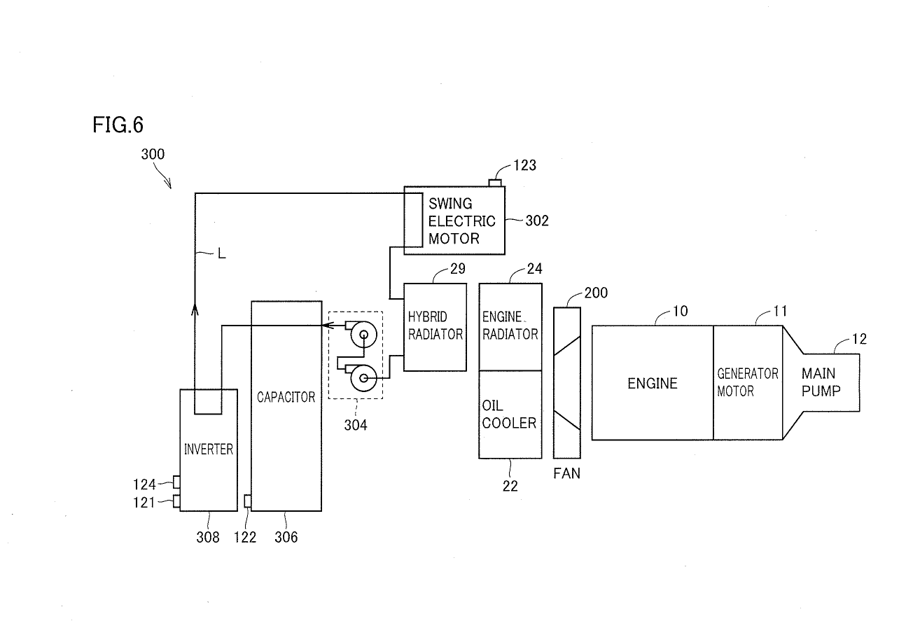

FIG. 6 is a diagram illustrating a cooling system 300 based on the embodiment.

As shown in FIG. 6, cooling system 300 (cooling medium circuit) of work vehicle 101 cools an electric motor system constituted of hybrid instruments.

In the present example, swing electric motor 302, inverter 308, capacitor 306, and the like as hybrid instruments are cooled by way of example. The hybrid instruments in the present example are electric instruments driven based on electric energy. Swing electric motor 302 is provided to be able to recover electric energy generated during deceleration of the revolving unit to which work implement 4 is coupled. Capacitor 306 is provided to be able to store electric energy. Inverter 308 is provided between swing electric motor 302 and capacitor 306, and controls storage of electric energy recovered by swing electric motor 302 in capacitor 306. Inverter 308 controls an operation of supplying electric power to swing electric motor 302 using electric energy stored in capacitor 306. It is noted that the hybrid instruments also include other electric instruments different from instruments described above.

Cooling system 300 includes a plurality of hybrid instruments (swing electric motor 302, inverter 308, capacitor 306), a circulation path L in communication with the plurality of hybrid instruments, hybrid radiator 29, and a coolant pump 304. It is noted that although the present example illustrates the structure where circulation path L communicates with capacitor 306, inverter 308 and swing electric motor 302 in series, the structure is not particularly limited to the structure where circulation path L communicates in series, but a structure where circulation path L communicates in parallel with them or where these structures are combined may be adopted.

By providing a common cooling medium circuit for the plurality of hybrid instruments, layout efficiency can be increased more than by providing individual cooling medium circuits independently.

Coolant pump 304 causes the hybrid coolant to circulate through circulation path L.

Hybrid radiator 29 is a radiator for cooling the hybrid coolant. The hybrid coolant in the radiator is cooled with cooling wind generated by fan 200.

In the present example, engine radiator 24 and oil cooler 22 constituting the cooling unit cooled by fan 200 is also shown.

Generator motor 11 and main pump 12, each being directly coupled to engine 10, are also shown. Main pump 12 is a pump for supplying a hydraulic oil with which work implement 4 is driven by driving of engine 10. Although the cooling system for cooling the hydraulic oil is not illustrated in detail, the hydraulic oil supplied from main pump 12 to work implement 4 is cooled by oil cooler 22 and is supplied again from main pump 12 to work implement 4.

Cooling system 300 further includes a plurality of temperature sensors. The plurality of temperature sensors are provided in correspondence with the plurality of hybrid instruments (swing electric motor 302, inverter 308 and capacitor 306), respectively, and each detect the temperature of corresponding hybrid instruments.

In the present example, cooling system 300 includes a swing electric motor temperature sensor 123 for detecting the temperature of swing electric motor 302, a capacitor temperature sensor 122 for detecting the temperature of a cell of capacitor 306, as well as inverter temperature sensors 121 and 124 for detecting the temperature of an inductor of inverter 308.

Inverter temperature sensor 121 is a sensor for detecting the temperature of a booster inductor among electronic components included in inverter 308.

Inverter temperature sensor 124 is a sensor for detecting the temperature of a booster IGBT (Insulated Gate Bipolar Transistor) among electronic components included in inverter 308.

It is noted that although the present example illustrates the temperature sensors each detecting the temperature of an electronic component in each hybrid instrument, but the electronic component is not a particular limitation, and these sensors can also be configured to detect the temperature of other electronic components. It is noted that although the present example illustrates the structure where at least one temperature sensor is provided for each hybrid instrument by way of example, a plurality of temperature sensors may be additionally provided to detect the state of electronic components of the hybrid instruments.

Since the hybrid instruments are electronic components, they could be rapidly raised in temperature in accordance with variations in load. To assure stable operations of the instruments, it is important to appropriately adjust them in temperature.

Since the present embodiment offers the structure where a common cooling medium circuit is provided for the plurality of hybrid instruments, it is not possible to specify which one of the hybrid instruments should be adjusted appropriately in temperature merely by detecting the temperature of the cooling medium. Therefore, the number of rotations of fan 200 is controlled based on the temperature detected by the temperature sensors provided for the plurality of hybrid instruments, respectively, as the state of electronic components of the plurality of hybrid instruments.

Moreover, in the present example, oil cooler 22 is provided with a hydraulic oil temperature sensor 130 for detecting the temperature of the hydraulic oil. It is possible to control the number of rotations of fan 200 also considering the temperature of the hydraulic oil detected by hydraulic oil temperature sensor 130 as will be described later.

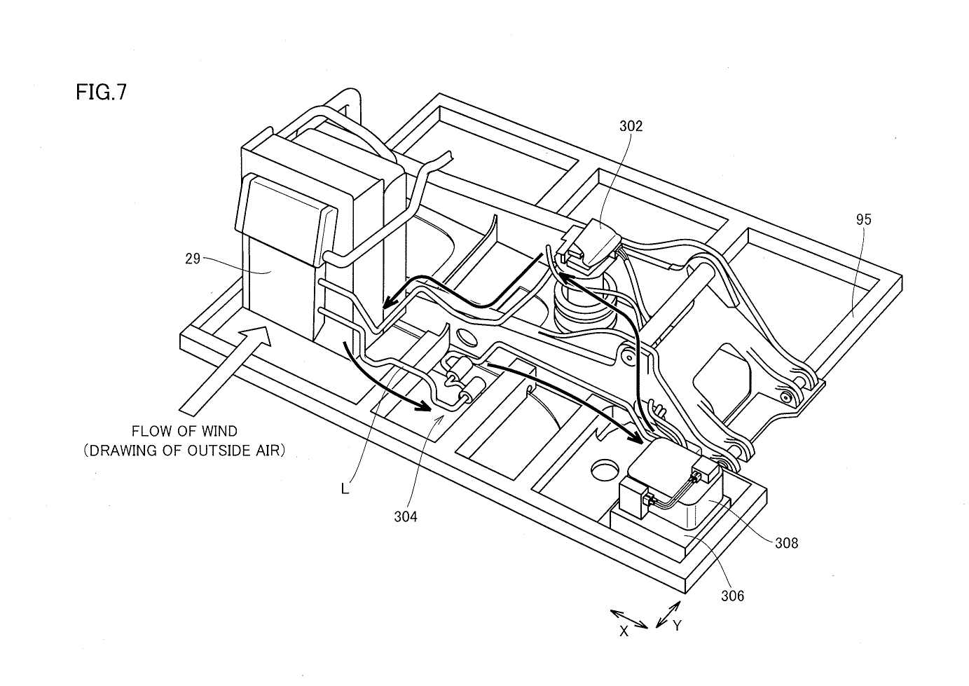

FIG. 7 is a diagram illustrating circulation path L of cooling system 300 based on the embodiment.

As shown in FIG. 7, swing electric motor 302, coolant pump 304 and capacitor 306 as the hybrid instruments are supported by a body frame 95. Inverter 308 is arranged on top of capacitor 306.

Inverter 308 and capacitor 306 are arranged at a front end portion (on the near side in the drawing) in the longitudinal direction (in the X direction) of body frame 95. Swing electric motor 302 is arranged at a central portion of body frame 95.

Hybrid radiator 29 is arranged at a rear end portion in the longitudinal direction (in the X direction) of body frame 95.

The present example shows the state where the hybrid coolant supplied from coolant pump 304 is supplied to capacitor 306, inverter 308, swing electric motor 302, and hybrid radiator 29 in the order presented through circulation path L, and returned again to coolant pump 304.

In cooling system 300, heat is exchanged between the hybrid coolant flowing through circulation path L and electronic components of the respective hybrid instruments.

<Fan Control System>

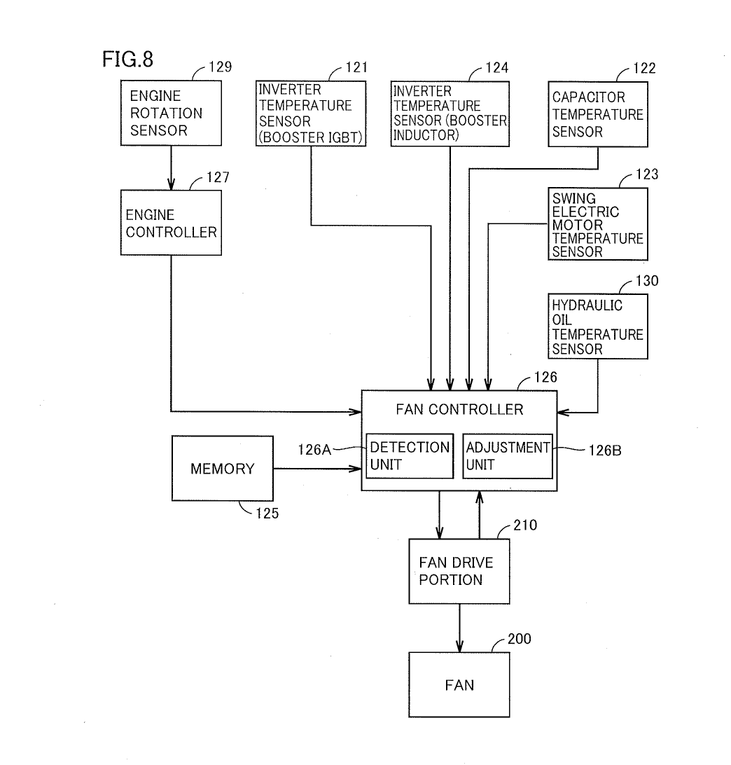

FIG. 8 is a functional block diagram for controlling fan 200 based on the embodiment.

Referring to FIG. 8, a fan control system includes an inverter temperature sensor (booster IGBT) 121, capacitor temperature sensor 122, swing electric motor temperature sensor 123, inverter temperature sensor (booster inductor) 124, a memory 125, a fan controller 126, an engine controller 127, an engine rotation sensor 129, hydraulic oil temperature sensor 130, fan drive portion 210, and fan 200.

Fan controller 126 obtains the number of rotations of the engine detected by engine rotation sensor 129, through engine controller 127.

Fan controller 126 obtains the temperature of inverter 308 detected by each of inverter temperature sensor (booster IGBT) 121 and inverter temperature sensor (booster inductor) 124.

Fan controller 126 obtains the temperature of capacitor 306 detected by capacitor temperature sensor 122.

Fan controller 126 obtains the temperature of swing electric motor 302 detected by swing electric motor temperature sensor 123.

Fan controller 126 obtains the temperature of the hydraulic oil detected by hydraulic oil temperature sensor 130.

Fan controller 126 includes a detection unit 126A for detecting the state of a hybrid instrument obtained by each temperature sensor, and an adjustment unit 126B for adjusting the number of rotations of fan 200 by controlling fan drive portion 210.

Adjustment unit 126B sets a target number of rotations of fan 200 based on various information stored in memory 125, and controls fan drive portion 210 to rotate fan 200 at the set target number of rotations.

Memory 125 stores a plurality of control maps (relationship data) for allowing fan controller 126 to set the number of rotations of fan 200 to the target number of rotations of fan 200.

<Control Map>

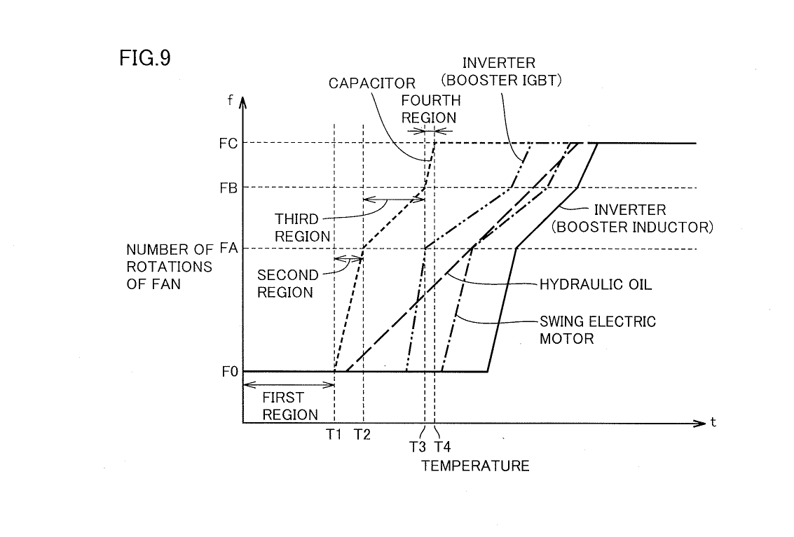

FIG. 9 is a diagram illustrating a structure of a plurality of control maps based on the embodiment.

As shown in FIG. 9, in the present example, control maps respectively provided in correspondence with the hybrid instruments are shown.

In the present example, an inverter (booster IGBT) control map, a capacitor control map, a swing electric motor control map, an inverter (booster inductor) control map, and a hydraulic oil control map (hydraulic oil relationship data) stored in memory 125 are shown by way of example.

A target number of rotations of fan 200 is set based on each of the control maps and the temperature detected by each of the temperature sensors.

In the control maps, a target number of rotations of fan 200 capable of ensuring a desired quantity of cooling air is set based on the performance of hybrid radiator 29. In accordance with the control maps, heat balance can be acquired when circulating the hybrid coolant through circulation path L to exchange heat with each hybrid instrument.

Here, a change rate of the number of rotations of the fan with respect to a temperature change on the control map provided in correspondence with each hybrid instrument is set to be higher than a change rate of the number of rotations of the fan with respect to a temperature change of the hydraulic oil on the hydraulic oil control map.

The hybrid instruments are implemented by electronic components. Temperature changes of electronic components are steeper than the temperature change of the hydraulic oil. Therefore, to assure stable operations of the electronic components, the change rate of the number of rotations of the fan with respect to the temperature changes of the hybrid instruments are set to be higher than the change rate of the number of rotations of the fan with respect to the temperature change of the hydraulic oil.

The control maps corresponding to the hybrid instruments each include a first region in which the change rate of the number of rotations of the fan with respect to a temperature change of a corresponding one of the hybrid instruments is low, a second region after the first region in which the change rate is higher than in the first region, a third region after the second region in which the change rate is lower than in the second region, and a fourth region after the third region in which the change rate is higher than in the third region.

In FIG. 9, the first to fourth regions are shown for the capacitor control map by way of example. The target number of rotations of fan 200 is adjusted in accordance with the temperature detected by capacitor temperature sensor 122.

In the first region, the target number of rotations of fan 200 is set at F0 until a temperature T1 is attained.

In the second region, the target number of rotations of fan 200 is set at F0 to FA when the temperature changes from T1 to T2.

In the third region, the target number of rotations of fan 200 is set at FA to FB when the temperature changes from T2 to T3.

In the fourth region, the target number of rotations of fan 200 is set at FB to FC when the temperature changes from T3 to T4.

In the present example, the first region in which the change rate of the target number of rotations with respect to the temperature change is 0 and the second region in which the change rate of the target number of rotations is high are provided until the target number of rotations is set at FA.

The third region in which the change rate of the target number of rotations with respect to the temperature change is low and the fourth region in which the change rate of the target number of rotations is high are provided until the target number of rotations is set at FC.

In this way, by providing regions in which the change rate of the target number of rotations with respect to the temperature change is low until the need for adjusting the number of rotations of fan 200 arises, it is possible to prevent unnecessary increase in the number of rotations of the fan. By reducing wasteful rotations of the fan, the engine output can be utilized efficiently, which can improve fuel efficiency.

The hydraulic oil control map is configured such that the number of rotations of the fan increases linearly with respect to the temperature change. On the other hand, the control maps corresponding to the hybrid instruments are specified such that transition is made from a region in which the change rate of the target number of rotations with respect to the temperature change is low to a region in which the change rate is high. Thus, the rotation of the fan can be restrained until the need for increasing the number of rotations of fan 200 arises, so that the fan can be controlled more efficiently.

Although in the present example, the structure of the control maps as relationship data defining the relationship between the temperature of each hybrid instrument and the number of rotations of the fan has been described, this structure is not a particular limitation, but any data that can define the relationship between them can be adopted. By way of example, the relationship data may be in the form of a data table defining the relationship between them or may be in the form of mathematical expressions defining the relationship between them.

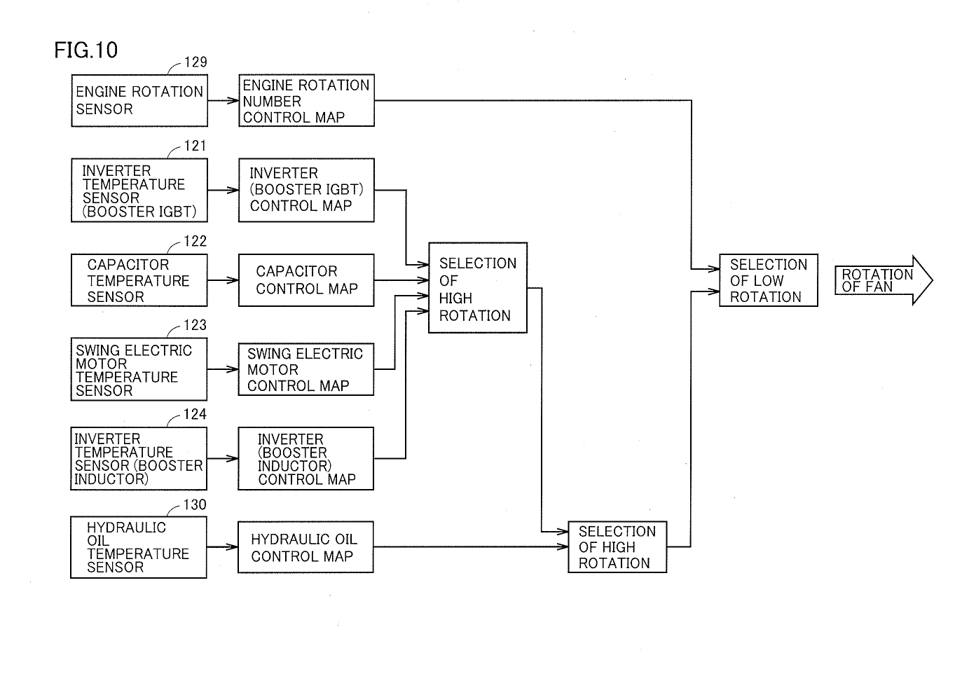

FIG. 10 is a conceptual diagram for controlling fan 200 using a plurality of control maps.

This processing is performed in detection unit 126A and adjustment unit 126B of fan controller 126.

As shown in FIG. 10, adjustment unit 126B sets the number of rotations of the fan with reference to a control map for the number of rotations of the engine stored in memory 125 in accordance with the number of rotations of the engine detected by engine rotation sensor 129. The control map for the number of rotations of the engine is a control map for setting the number of rotations of fan 200 via fan drive portion 210 in accordance with the number of rotations of engine 10.

Adjustment unit 126B sets the number of rotations of the fan with reference to the inverter (booster IGBT) control map stored in memory 125 in accordance with the temperature detected by inverter temperature sensor 121.

Adjustment unit 126B sets the number of rotations of the fan with reference to the capacitor control map stored in memory 125 in accordance with the temperature detected by capacitor temperature sensor 122.

Adjustment unit 126B sets the number of rotations of the fan with reference to the swing electric motor control map stored in memory 125 in accordance with the temperature detected by swing electric motor temperature sensor 123.

Adjustment unit 126B sets the number of rotations of the fan with reference to the inverter (booster inductor) control map stored in memory 125 in accordance with the temperature detected by inverter temperature sensor 124.

Adjustment unit 126B sets the number of rotations of the fan with reference to the hydraulic oil control map stored in memory 125 in accordance with the temperature detected by hydraulic oil temperature sensor 130.

As described above, adjustment unit 126B sets the number of rotations of the fan with reference to the control maps stored in memory 125 in accordance with the temperatures detected by the plurality of temperature sensors.

Adjustment unit 126B selects the highest number of rotations from among the numbers of rotations of the fan set with reference to the numbers of rotations of the fan set with reference to the control maps.

In the present example, the highest number of rotations of the fan necessary for cooling is selected based on the state of the plurality of hybrid instruments (i.e., selection of high rotation).

Furthermore, since the cooling unit includes oil cooler 22 as well as hybrid radiator 29 as described above, adjustment unit 126B compares the number of rotations of the fan based on the state of the plurality of hybrid instruments and the number of rotations of the fan set with reference to the hydraulic oil control map in accordance with the temperature of the hydraulic oil to select the highest number of rotations (i.e., selection of high rotation).

Subsequently, adjustment unit 126B selects a lower number of rotations of the fan, from among the number of rotations of the fan set with reference to the control map for the number of rotations of the engine and the highest number of rotations of the fan described above (i.e., selection of low rotation).

Fan 200 is coupled to the output shaft of engine 10 via fan drive portion 210, and is rotated by means of the drive force of engine 10. Accordingly, the number of rotations of the fan set in accordance with the control map for the number of rotations of the engine is the maximum number of rotations of the fan which can be rotated by driving the engine. Therefore, when the selected highest number of rotations of the fan (i.e., selection of high rotation) is larger than the number of rotations of the fan set in accordance with the control map for the number of rotations of the engine, the number of rotations of the fan is restricted to the maximum number of rotations of the fan set in accordance with the control map for the number of rotations of the engine.

On the other hand, when the selected highest number of rotations of the fan (i.e., selection of high rotation) is smaller than or equal to the number of rotations of the fan set in accordance with the control map for the number of rotations of the engine, the number of rotations of the fan is set to the selected highest number of rotations of the fan (i.e., selection of high rotation). Fan 200 can be efficiently rotated without being rotated at an excessive number of rotations of the fan.

By the scheme described above, the number of rotations of the fan can be appropriately adjusted based on the plurality of control maps, also in consideration of the state of other cooling objects.

<Others>

Although a hydraulic excavator has been described by way of example as a work vehicle in the present example, the present invention is also applicable to a work vehicle such as a bulldozer or a wheel loader.

Although the embodiment of the present invention has been described above, it should be understood that the embodiment disclosed herein is illustrative and non-restrictive in every respect. The scope of the present invention is defined by the scope of the claims, and is intended to include any modifications within the scope and meaning equivalent to the scope of the claims.

### REFERENCE SIGNS LIST 1: carrier; 3: revolving unit; 4: work implement; 5: boom; 6: arm; 7: bucket; 10:

engine; 11: generator motor; 12: main pump; 17: fan cover; 22: oil cooler; 24: engine radiator; 29: hybrid radiator; 95: body frame; 101: work vehicle; 121, 124: inverter temperature sensor; 122: capacitor temperature sensor; 123: swing electric motor temperature sensor; 125: memory; 126: fan controller; 126A: detection unit; 126B: adjustment unit; 127: engine controller; 129: engine rotation sensor; 130: hydraulic oil temperature sensor; 200: fan; 202: output shaft; 210: fan drive portion; 214: solenoid coil; 215: hall element; 216: solenoid movable element; 220: adjustment member; 221: spring; 230: clutch portion; 240: case; 300: cooling system; 302: swing electric motor; 304: coolant pump; 306: capacitor; 308: inverter.

30

1. A work vehicle, comprising:
a plurality of hybrid instruments;
a cooling medium circuit communicating with said plurality of hybrid instruments to cause a cooling medium for cooling said plurality of hybrid instruments to circulate through said hybrid instruments;
a radiator connected to said cooling medium circuit;
a fan for generating cooling wind for cooling said radiator;
a variable mechanism capable of changing a number of rotations of said fan;
a plurality of sensors provided in correspondence with said plurality of hybrid instruments, respectively, each detecting a temperature of a corresponding one of said hybrid instruments; and
a fan control unit for controlling said variable mechanism based on the temperatures of said hybrid instruments detected by said plurality of sensors to control the number of rotations of said fan.

2. The work vehicle according to claim 1, further comprising a storage unit for storing a plurality of pieces of relationship data defining relationship between the temperatures of said hybrid instruments and the number of rotations of said fan in accordance with said plurality of hybrid instruments,
wherein said fan control unit controls the number of rotations of said fan to be the highest number of rotations among numbers of rotations set in accordance with the plurality of pieces of relationship data stored in said storage unit based on the temperatures detected by said plurality of sensors, respectively.

3. The work vehicle according to claim 2, wherein
said fan control unit controls said variable mechanism based on a temperature of a hydraulic oil used in said work vehicle and the temperatures detected by said plurality of sensors to control the number of rotations of said fan,
said storage unit further stores hydraulic oil relationship data for setting the number of rotations of the fan at a different number of rotations of the fan in accordance with the temperature of the hydraulic oil for cooling said hydraulic oil, and
a change rate of the number of rotations of the fan from the minimum number of rotations to the maximum number of rotations with respect to a temperature change of each of said hybrid instruments is higher than a change rate of the number of rotations of the fan from the minimum number of rotations to the maximum number of rotations with respect to a temperature change of said hydraulic oil in said hydraulic oil relationship data.

4. The work vehicle according to claim 2, wherein the plurality of pieces of relationship data each include a first region in which a change rate of the number of rotations of the fan with respect to a temperature change of a corresponding one of said hybrid instruments is low, and a second region after said first region in which said change rate is higher than in said first region.

5. The work vehicle according to claim 1, further comprising an engine for supplying a drive force for rotation to said fan,
wherein said variable mechanism is provided between said engine and said fan.

6. The work vehicle according to claim 1, wherein said plurality of hybrid instruments at least include an electric motor capable of recovering electric energy generated during deceleration of a revolving unit, a capacitor for storing electric energy, and an inverter for controlling storage of electric energy recovered by said electric motor in said capacitor.
